(19) United States
(12) Patent Application Publication
(10) Pub. No.: US 2023/0161949 A1
(43) Pub. Date: May 25, 2023

(54) INTELLIGENT CONTENT IDENTIFICATION AND TRANSFORMATION

(71) Applicant: Microsoft Technology Licensing, LLC, Redmond, WA (US)

(72) Inventors: Chenguang YANG, Seattle, WA (US); Mahaveer Bhavarlal KOTHARI, Redmond, WA (US)

(73) Assignee: Microsoft Technology Licensing, LLC, Redmond, WA (US)

(21) Appl. No.: 17/919,197

(22) PCT Filed: Apr. 16, 2021
(86) PCT No.: PCT/US2021/027578

§ 371 Date: Oct. 14, 2022

(30) Foreign Application Priority Data
Apr. 24, 2020 (NL) 2025417

(51) Int. Cl. G06F 40/166; G06F 40/103; G06F 16/9532; G06F 16/954

(52) U.S. Cl. CPC G06F 40/166; G06F 40/103; G06F 16/9532; G06F 16/954

(57) ABSTRACT

Intelligently identifying and transforming content for use in a document includes transmitting a search query generated within a content creation application used for creating content for the document, the search query containing terms for conducting a search for content, providing the terms to a search engine for searching sources, receiving search results from the search engine, inputting data contained in the search results into a first machine-learning (ML) model to parse the inputted data and rank relevance of the inputted data to content associated with the document, obtaining the parsed and ranked data as a first output from the first ML model, retrieving data segments from the first output, inputting the retrieved segments into a second ML model to organize the data segments into units of content, obtaining the units of content as an output from the second ML model, and providing the output for display within the application.

### TECHNICAL FIELD

This disclosure relates generally to intelligent transformation of content, and, more particularly, to automatically discovering and transforming content obtained from one or more sources to a format that is compatible with and can be inserted into a document.

### BACKGROUND

Computer users often use various content creation applications to create content in the form of a document. For example, users may utilize an application to create a presentation, another to prepare a spreadsheet and yet another to generate a word document.

Often during the content creation process, the users may need to search various sources for information related to the document they are creating. This may require the user to identify various sources, conduct multiple searches, study the search results, and determine which portions of the search results relate to and can be used in their document.

Once relevant information is identified, the users may need to determine how to transfer the identified information to their document. This may involve copying various portions separately, determining where to place the copied portion, identifying how to format the new information and the like. This is often a time consuming and tedious process. Furthermore, depending on the user's proficiency level with respect to the application, the user may or may not be able to properly transform and format the information.

Hence, there is a need for improved systems and methods of intelligently transforming content.

### SUMMARY

In one general aspect, the instant application describes a data processing system having a processor and a memory in communication with the processor wherein the memory stores executable instructions that, when executed by the processor, cause the data processing system to perform multiple functions. The functions may include receiving a search query generated within a content creation application, the content creation application used for creating content for a document and the search query containing one or more terms for conducting a search for content to be used in the document, providing the one or more terms to a search engine for searching one or more sources, and receiving one or more search results from the search engine. The functions may also include inputting data contained in at least one of the one or more search results into a first machine-learning (ML) model to parse the inputted data and rank relevance of the inputted data to content associated with the document; obtaining the parsed and ranked data as a first output from the first ML model, retrieving one or more data segments from the first output, inputting the retrieved one or more segments into a second ML model to organize the retrieved one or more data segments into one or more units of content that can be used in the document, obtaining the one or more units of content as a second output from the second ML model, and providing the second output for display within the content creation application.

In yet another general aspect, the instant application describes a method for identifying and transforming content for use in a document. The method may include receiving a search query generated within a content creation application, the content creation application used for creating content for the document and the search query containing one or more terms for conducting a search for content to be used in the document, providing the one or more terms to a search engine for searching one or more sources, and receiving one or more search results from the search engine. The method may also include inputting data contained in at least one of the one or more search results into a first machine-learning (ML) model to parse the inputted data and rank relevance of the inputted data to content associated with the document, obtaining the parsed and ranked data as a first output from the first ML model, retrieving one or more data segments from the first output, inputting the retrieved one or more segments into a second ML model to organize the retrieved one or more data segments into one or more units of content that can be used in the document, obtaining the one or more units of content as a second output from the second ML model, and providing the second output for display within the content creation application.

In a further general aspect, the instant application describes a non-transitory computer readable medium on which are stored instructions that when executed cause a programmable device to receive a search query generated within a content creation application, the content creation application used for creating content for the document and the search query containing one or more terms for conducting a search for content to be used in the document, provide the one or more terms to a search engine for searching one or more sources, and receive one or more search results from the search engine. The computer readable medium may further include instructions that when executed cause a programmable device to input data contained in at least one of the one or more search results into a first machine-learning (ML) model to parse the inputted data and rank relevance of the inputted data to content associated with the document, obtain the parsed and ranked data as a first output from the first ML model, retrieve one or more data segments from the first output, input the retrieved one or more segments into a second ML model to organize the retrieved one or more data segments into one or more units of content that can be used in the document, obtaining the one or more units of content as a second output from the second ML model, and provide the second output for display within the content creation application

In yet a further general aspect, the instant application describes a computer program that, when executed, causes a programmable device to carry out the method of receiving a search query generated within a content creation application, the content creation application used for creating content for the document and the search query containing one or more terms for conducting a search for content to be used in the document, providing the one or more terms to a search engine for searching one or more sources, and receiving one or more search results from the search engine. The method may also include inputting data contained in at least one of the one or more search results into a first machine-learning (ML) model to parse the inputted data and rank relevance of the inputted data to content associated with the document, obtaining the parsed and ranked data as a first output from the first ML model, retrieving one or more data segments from the first output, inputting the retrieved one or more segments into a second ML model to organize the retrieved one or more data segments into one or more units of content that can be used in the document, obtaining the one or more units of content as a second output from the second ML model, and providing the second output for display within the content creation application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A-1C depict an example system upon which aspects of this disclosure may be implemented.

FIGS. 2A-2D are example graphical user interface (GUI) screens for enabling a user to search for content for use in a document and for presenting content developed for the document to the user.

FIG. 3 depicts the content of an example search result used in intelligently transforming content.

FIG. 4 depicts a simplified example data structure utilized for collecting data from one or more search results to use in creating a unit of content for a content creation application.

FIG. 5 is a flow diagram depicting an example method for providing intelligent content identification and transformation.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Users often spend a significant amount of time searching for information to include in documents they are creating and/or converting information they have already discovered in one type of document to a format usable in their own document. This is particularly the case when a user is not proficient in searching and/or in digital content creation. For example, the user may not be aware of the formatting features available in the content creation application used for creating their document. In another example, the user may not be proficient in parsing and/or aggregation the discovered information or in determining a proper place in the document for inserting the discovered information. This is made further complicated because information collected in a search may originate from many different types of sources. For example, some may originate from webpages, while others may be located in a database (e.g., tabular data structures in a data store). Some of these sources of information may not be easily conducive to a copy/paste operation. Others may require multiple copy/paste operations to transfer the desired content. This may require a lot of time and effort on the part of the user. Furthermore, depending on the number of searches conducted and the amount of data copied, the repeated operations may require substantial bandwidth and system resources. Thus, currently available applications suffer from the technical problem of failing to provide a mechanism by which a user can easily and efficiently locate and transfer information relating to the document they are creating into their document. As a result, users often spend a significant amount of time and computer resources searching for and determining how to transfer information into their documents.

To address these technical problems and more, in an example, this description provides a technical solution used for intelligently discovering and transferring content to a document. To do so, techniques may be used to receive a request to search for information, receive search results related to the document, review the search results regardless of the type of source from which they originate to automatically discover information relevant to the user's requested search and/or the document, retrieve the identified information, transform the information from their data structure to a data structure usable in the document, aggregate the information to prepare a unit of content that is usable in the document, and present the prepared unit of content to the user for insertion into the document. As a result, the technical solution provides an improved method of locating and inserting information into a document by enabling the user to easily search for desired information from within the document creation application and automatically receive the information in a format that is insertable into the document.

As will be understood by persons of skill in the art upon reading this disclosure, benefits and advantages provided by such implementations can include, but are not limited to, optimizing both the process of identifying information for insertion into a document and the process of transforming the identified information into a format compatible with the document. This may be achieved by utilizing one or more rule-based classification and transformation algorithms and/or machine learning (ML) models that quickly and efficiently identify appropriate sources to search, locate relevant information in the identified search results, and transform the relevant information into a format usable in the document. The results may be presented to the user in a format that can be easily inserted into the document. This may eliminate the need for the user to perform multiple searches, parse the search results to identify relevant information, and determine how to convert the relevant information into a format that can be used in their document. Thus, the technical solution can significantly increase efficiency and improve the quality of content created by users. This not only increases the user's efficiency, it can also increase system efficiency by for example, reducing the number of times searches need to be performed or the number of documents that need to be downloaded to retrieve relevant information. The benefits provided by these technology-based solutions yield more user-friendly applications, enhanced content and increased system and user efficiency.

As a general matter, the methods and systems described herein may include, or otherwise make use of, a machine-trained model to identify sources to search for, identify relevant data in the identified search results, and determine how to aggregate and format the relevant data. Machine learning (ML) generally includes various algorithms that a computer automatically builds and improves over time. The foundation of these algorithms is generally built on mathematics and statistics that can be employed to predict events, classify entities, diagnose problems, and model function approximations. As an example, a system can be trained using data generated by an ML model in order to identify patterns in user activity, determine associations between content, determine how to aggregate and/or format content for a given document. Such training may be made following the accumulation, review, and/or analysis of user data from a large number of users over time, and which is configured to provide the ML algorithm (MLA) with an initial or ongoing training set. In addition, in some implementations, a user device can be configured to transmit data captured locally during use of relevant application(s) to a local or remote ML program and provide supplemental training data that can serve to fine-tune or increase the effectiveness of the MLA. The supplemental data can also be used to improve the training set for future application versions or updates to the current application.

In different implementations, a training system may be used that includes an initial ML model (which may be referred to as an “ML model trainer”) configured to generate a subsequent trained ML model from training data obtained from a training data repository or from device-generated data. The generation of both the initial and subsequent trained ML model may be referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying ML algorithms, such as, but not limited to, decision trees, random decision forests, neural networks, deep learning (for example, convolutional neural networks), support vector machines, regression (for example, support vector regression, Bayesian linear regression, or Gaussian process regression) may be trained. As another example, size or complexity of a model may be varied between different ML models, such as a maximum depth for decision trees, or a number and/or size of hidden layers in a convolutional neural network. As another example, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model may be produced.

The training data may be continually updated, and one or more of the ML models used by the system can be revised or regenerated to reflect the updates to the training data. Over time, the training system (whether stored remotely, locally, or both) can be configured to receive and accumulate more training data items, thereby increasing the amount and variety of training data available for ML model training, resulting in increased accuracy, effectiveness, and robustness of trained ML models.

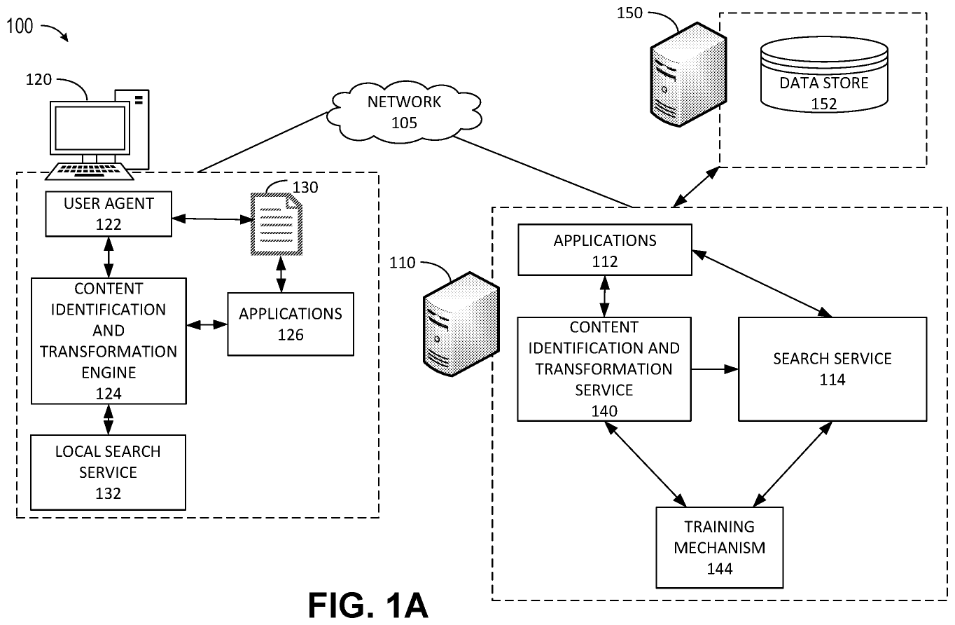

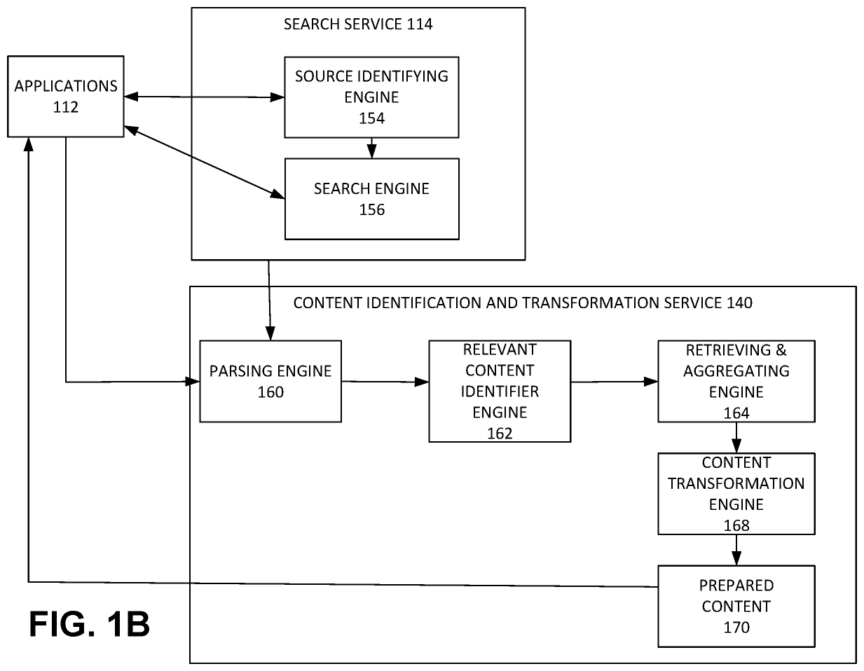

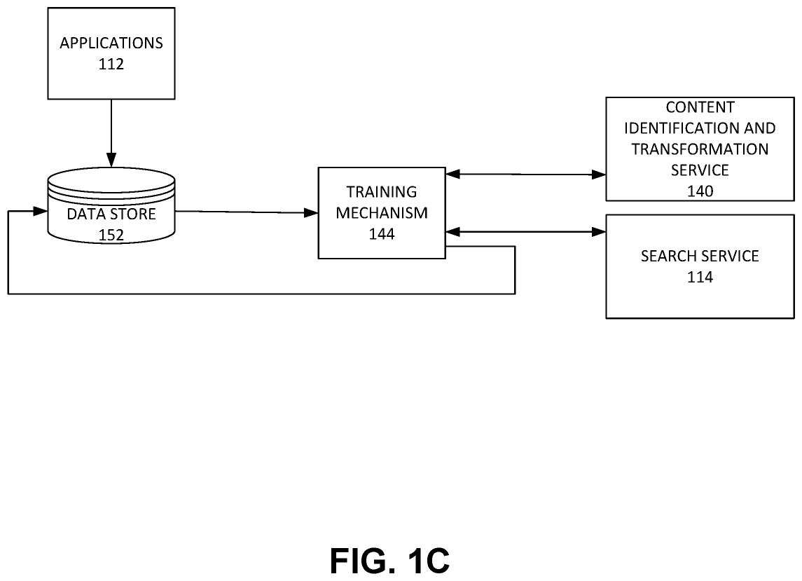

FIG. 1A illustrates an example system 100, upon which aspects of this disclosure may be implemented. The system 100 may include a sever 110 which may contain and/or execute a content identification and transformation service 140 and a search service 114. The server 110 may operate as a shared resource server located at an enterprise accessible by various computer client devices such as client device 120. The server 110 may also operate as a cloud-based server for offering global content identification and transformation services. Although shown as one server, the server 110 may represent multiple servers for performing various different operations. For example, the server 110 may include one or more processing servers for performing the operations of the content identification and transformation service 140 and the search service 114.

The search service 114 may provide intelligent searching for information requested by a user and/or related to a document. This may be achieved by receiving a search request from a user (e.g., from an application utilized by the user) where the search request includes one or more search terms. The search service 114 may then examine the one or more search terms to identify one or more appropriate sources to search for information relevant to the document. In identifying the relevant sources, in addition to the search term(s), the search service 114 may take into account contextual information relating to the document, the user and/or other relevant parameters. After relevant sources have been identified, the search service 114 may conduct one or more searches to provide relevant search results. In one implementation, in providing the relevant search results, the search service 114 may perform relevance ranking to identify the more relevant search results. It should be noted that although the search service 114 is shown as a separate service, in one implementation, the operations of the search service 114 may be performed by the content identification and transformation service 140, as part of any other service, or as part of a user's local client device. It should also be noted that a search may include searching by one or more keywords, natural language, and/or other terms identified as being associated with the search terms.

The content identification and transformation service 140 may provide intelligent content identification and transformation. This may be achieved by receiving relevant search results from the search service 140, examining the relevant search results to understand their content, identifying content in the search results that may be relevant to the document, retrieving and transforming the relevant content into an easily usable format, summarizing the content or synthesizing new content or new summaries from existing content, transforming the content or summaries to a format presentable to a user, and transmitting the presentable content for display to the user.

The server 110 may be connected to or include a storage server 150 containing a data store 152. The data store 152 may function as a repository in which documents and/or data sets (e.g., training data sets) may be stored. One or more ML models used by the content identification and transformation service 140 and/or the search service 114 may be trained by a training mechanism 144. The training mechanism 144 may use training data sets stored in the data store 152 to provide initial and ongoing training for each of the models. Alternatively or additionally, the training mechanism 144 may use training data sets unrelated to the data store. This may include training data such as knowledge from public repositories (e.g., Internet), knowledge from other enterprise sources, or knowledge from other pre-trained mechanisms. In one implementation, the training mechanism 144 may use labeled training data from the data store 152 to train each of the models via deep neural network(s) or other types of ML algorithms. Alternatively or additionally, the training mechanism 144 may use unlabeled training data. The initial training may be performed in an offline stage or may be performed online. Additionally and/or alternatively, the one or more ML models may be trained using batch learning.

It should be noted that the ML model(s) identifying relevant sources to search, relevant search results to present, understanding content, identifying relevant content, retrieving content and/or transforming the content may be hosted locally on the client device 120 or remotely, e.g., in the cloud. In one implementation, some ML models are hosted locally, while others are stored remotely. This may enable the client device 120 to provide some content identification and transformation even when the client is not connected to a network.

The server 110 may also be connected to or include one or more online applications 112. Applications 112 may be representative of applications that enable creation or editing of one or more documents. Examples of suitable applications include, but are not limited to a word processing application, a presentation application, a note taking application, a text editing application, an email application, a spreadsheet application, a desktop publishing application, and a digital drawing application.

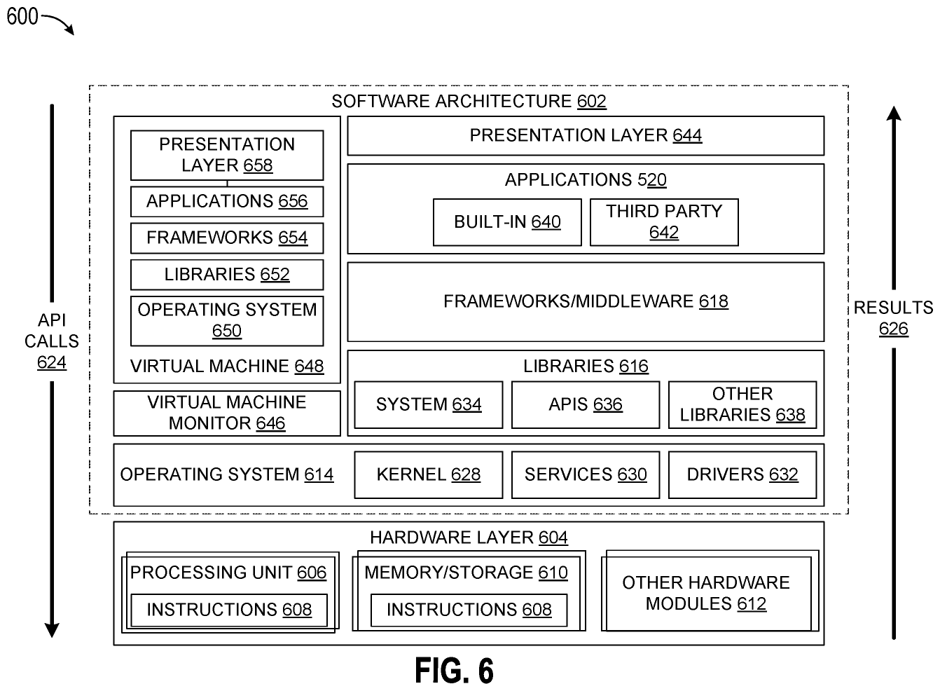

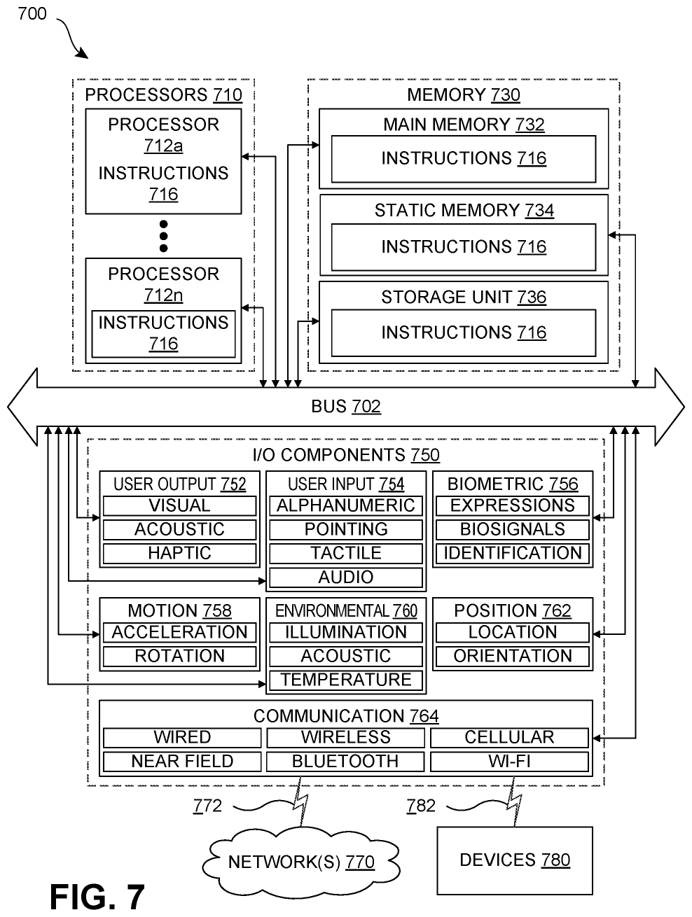

The client device 120 may be connected to the server 110 via a network 105. The network 105 may be a wired or wireless network(s) or a combination of wired and wireless networks that connect one or more elements of the system 100. The client device 120 may be a personal or handheld computing device having or being connected to input/output elements that enable a user to interact with a document 130 on the client device 120 and to submit a search request via, for example, a user interface (UI) displayed on the client device 120. Examples of suitable client devices 120 include but are not limited to personal computers, desktop computers, laptop computers, mobile telephones, smart phones, tablets, phablets, digital assistant devices, smart watches, wearable computers, gaming devices/computers, televisions, and the like. The internal hardware structure of a client device is discussed in greater detail in regard to FIGS. 6 and 7.

The client device 120 may include one or more applications 126. An application 126 may be a computer program executed on the client device that configures the device to be responsive to user input to allow a user to interactively view, generate and/or edit the document 130 and/or to enable the user to conduct a search. The document 130 and the term document used herein can be representative of any file that can be created via an application executing on a computer device. Examples of documents include but are not limited to word-processing documents, presentations, spreadsheets, notebooks, websites (e.g., SharePoint sites), digital drawings, emails, media files and the like. The document 130 may be stored locally on the client device 120, stored in the data store 152 or stored in a different data store and/or server.

The application 126 may process the document 130, in response to user input through an input device, to create, view and/or modify the content of the document 130, by displaying or otherwise presenting display data, such as a GUI which includes the content of the document 130, to the user. In another example, the application 126 may enable the user to provide input via an input/output element to request a search for content to use in the document. Examples of suitable applications include, but are not limited to a word processing application, a presentation application, a note taking application, a text editing application, an email application, a spreadsheet application, a desktop publishing application, a digital drawing application and a communications application.

The client device 120 may also access applications 112 that are run on the server 110 and provided via an online service as described above. In one implementation, applications 112 may communicate via the network 105 with a user agent 122, such as a browser, executing on the client device 120. The user agent 122 may provide a UI that allows the user to interact with application content and documents stored in the data store 152 via the client device 120. The user agent 122 may also provide a UI that enables the user to conduct a search for content to include in the document. In some examples, the user agent 122 may be a dedicated client application that provides a UI to access documents stored in the data store 152 and/or in various other data stores.

In one implementation, the client device 120 may also include a content identification and transformation engine 124 for providing some intelligent content identification and transformation for documents, such as the document 130. In an example, the local content identification and transformation engine 124 may operate with the applications 126 to provide local content identification and transformation services. For example, when the client device 120 is offline, the local content identification and transformation engine may make use of one or more local repositories to identify and transform relevant content for using in a document. In one implementation, enterprise-based repositories that are cached locally may also be used to provide local content identification and transformation.

To provide local content identification and transformation, in one implementation, the client device 120 may include a local search service 132 for conducting a search for information stored in a local storage medium (e.g., local memory of the client device 120). The local search service 132 may include a local ranking engine and a local search engine.

It should also be noted that each of the search service 114, content identification and transformation service 140, content identification and transformation engine 124, and local search service 132 may be implemented as software, hardware, or combinations thereof.

FIG. 1B depicts various elements included in each of the search service 114 and the content identification and transformation service 140. As discussed above, the search service 114 may receive a search request (e.g., search query) from applications 112 (or application 126). This may occur, for example, when the user utilizes an input/output device (e.g. a mouse) coupled to the client device 120 to insert one or more search terms (e.g., keywords, natural language, or other terms) in a UI element to request that prepared content related to the search term(s) be provided for the document. In addition to the search terms, the search request may also include other information that can be used to efficiently search for and identify relevant content. This may include contextual information about the document, the user and/or other relevant information. For example, information about the type of document (e.g., word document, email, presentation document, etc.), the topic of the document, the position of the user within an organization (e.g., the user's job title or department to which the user belongs, if known), other non-linguistic features such as the person to whom the document is directed, and the like may be transmitted with the search request.

The search service 114 may include a source identifying engine 154 and a search engine 156. The source identifying engine 154 may receive the search request and identify one or more sources to search based on various parameters. To achieve this, the source identifying engine 154 may make use of a classifier that examines the one or more search terms, classifies the search terms based on predetermined parameters (e.g., based on subject matter by using one or more models relating to text classification and topic modeling) and determines based on the classification which source(s) should be used for conducting the search. This may involve use of one or more ML models. As such, the source identifying engine 154 may include one or more ML models. The sources may be publicly available sources (e.g., public webpages), sources associated with the application, enterprise sources (e.g., business intelligence and analytics data structures), and/or sources associated with the user (e.g., local or cloud storage). Thus, the source identifying engine 154 may receive the search request along with other relevant information as inputs and provide revenant sources for searching as an output.

The identified relevant sources may be provided as an input to the search engine 156 which may also receive the search request (along with additional contextual information relating to the search request) from the applications 112. The search engine 156 may use the received input to conduct one or more searches of the relevant sources to identify search results. In one implementation, in addition to identifying search results, the search engine 156 may also perform relevance ranking to identify the more relevant search results. Thus, the search engine 156 may output relevant search results. The relevant search results may be transmitted to the content identification and transformation service 140 for further processing.

In one implementation, the content identification and transformation service 140 may include a parsing engine 160, relevant content identifier engine 162, retrieving and aggregating engine 164, and content transformation engine 168, all of which may be utilized to provide a prepared content 170 as an output. The parsing engine 160 may receive the relevant search results as an input from the search service 114 along with additional inputs from the applications 112. The additional input may include relevant information (e.g., contextual information about the document, the user, and/or other information). The parsing engine 160 may use the inputs to parse one or more of the top search results. This may involve classifying the data in the one or more top search results (e.g., topic classification). In one implementation, this is achieved by utilizing features provided by each type of search result. For example, when the search result is a webpage, a word document or a PDF document, headings may be used to classify the data. In an example, this may involve identifying data that is categorized under a particular heading as being related to that heading. For example, data that is positioned under the heading geography, may be identified as being related to geography. Thus, the parsing engine 160 may receive the relevant search results as an input and provide parsed and/or classified content within one or more the relevant search results as an output.

The parsed and/or classified content may then be provided to the relevant content identifier engine 162. The relevant content identifier engine 162 may utilize the classified content and compare the classifications to the search request and contextual information about the document and/or the user to identify segments of the classified content that may be relevant to the document and/or the user. In this manner, the relevant search results are examined to understand their content and determine the relevance of the content to the document and/or the user. The relevant content identifier engine 162 may receive the search request and/or contextual information about the document and/or the user directly from the applications 112 or from the parsing engine 160. Thus, the relevant content identifier engine 162 may receive the parsed content, search request and/or contextual information about the document and/or the user as inputs and provide relevant content within one or more the parsed search results as an output.

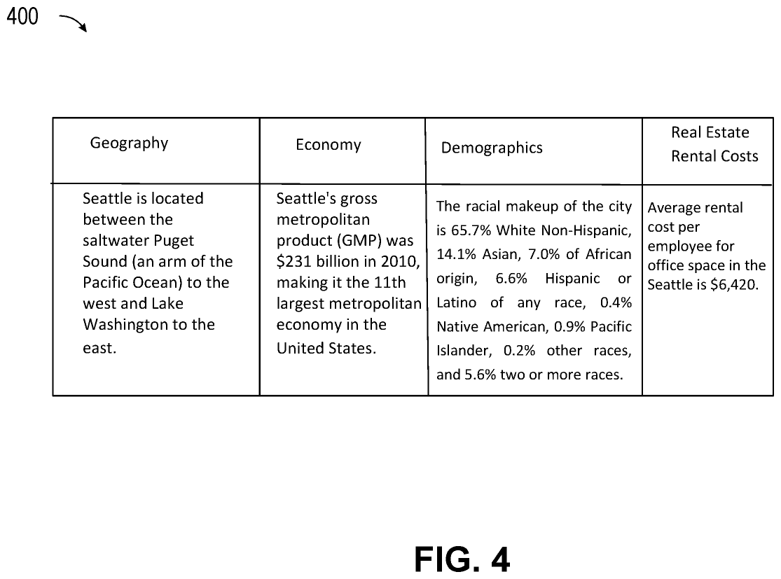

The relevant content may then be provided to the retrieving and aggregation engine 164 as an input. The retrieving and aggregation engine 164 may extract the relevant content from the parsed search result(s) by transferring the data to a data structure such as the data structure 400 of FIG. 4, discussed below. This may involve extracting and/or organizing the relevant content based on their identified classification (e.g., all data related to geography may be copied from the search result into the same row, column or cell of a tubular data structure). In one implementation, some of the formatting present in the relevant content may be removed prior to pasting the data to the data structure. For example, if the copied data includes a numbered list, the numbers may be removed. This may be done to provide a uniform format for the data within the data structure. When organizing the content based on their classification, data from multiple search results or from different portions of one search result may be aggregated into the same row, column or cell of a tubular data structure. Thus, the retrieving and aggregation engine 164 may receive the relevant content as an input and provide a data structure containing retrieved and/or aggregated content as an output.

The retrieved and/or aggregated content may be provided to the content transformation engine 168 as an input. Additionally, the content transformation engine 168 may receive information about the document and/or the user (and other users similar to the user or a global database of users) as additional inputs. This information may include the type of document for which content is being created (e.g., the type of application the document is being generated in and contextual information about the document being a research paper or a user manual, and the like), preferences of the user (e.g., the user prefers to use bullet points for certain type of information), and information about other users (e.g., users similar to the user or global users prefer to format this type of data in a tabular manner). The inputs may then be used to convert the information contained in the retrieved and/or aggregated content to formats that can be directly used in the document. This may include identifying the type of unit of content that can be utilized in the document (e.g., a paragraph, a slide, a table, and the like), organizing the retrieved and/or aggregated content into one or more units and then formatting the units appropriately. This may involve, for example, converting information contained within a long paragraph to a well-structured bullet point list. Thus, the content transformation engine 168 may receive the retrieved and/or aggregated content as an input and provide the prepared content 170 as an output.

The prepared content 170 may be a ready-to-insert content unit that a user can insert directly from their traditional content creation application without having to use dedicated query/analysis applications. In one implementation, the prepared content may include multiple ready-to-insert content units (e.g., multiple paragraphs, multiple slides, and the like). In an example, when there are multiple ready-to-insert content units, some may be organized into one or more files based on various parameters such as their subject matter. For example, a search for the term “Seattle” may result in creating 15 slides for a presentation document. A few of those slides may relate to geography. The geography slides may be organized into one file and presented as such to the user such that the user does not have to separately view them if they are not interested in geography related information. Once the prepared content is ready, it may be supplied (e.g., transmitted) to the application 112 to be displayed to the user to enable direct insertion of the content.

It should be noted a that the local search service 132 of the client device 120 (in FIG. 1A) may include similar elements and may function similarly as the search service 114 (as depicted in FIG. 1B). Furthermore, the content identification and transformation engine 124 of the client device 120 (in FIG. 1A) may include similar elements and may function similarly as the content identification and transformation 140 (as depicted in FIG. 1B).

FIG. 1C depicts how one or more ML models used by the content identification and transformation service 140 and the search service 114 may be trained by using the training mechanism 144. The training mechanism 144 may use training data sets stored in the data store 152 to provide initial and ongoing training for each of the models included in the content identification and transformation service 140 and/or the search service 114. For example, each of source identifying engine, search engine, parsing engine, relevant content identifier engine 162, retrieving and aggregating engine 164 and content transformation engine 168 may be trained by the training mechanism 144 using corresponding data sets from the data store 152. To train these ML models, the training mechanism may receive data sets relevant to the inputs each of the ML models receive during the operation, as discussed above with respect to FIG. 1B to train the models. To provide ongoing training, the training mechanism 144 may also use training data sets received from each of the ML models (models included in the content identification and transformation service 140 and/or the search service 114). Furthermore, unrelated to the data store. Furthermore, data may be provided from the training mechanism 144 to the data store 152 to update one or more of the training data sets in order to provide updated and ongoing training. Additionally, the training mechanism 144 may receive training data such as knowledge from public repositories (e.g., Internet), knowledge from other enterprise sources, or knowledge from other pre-trained mechanisms.

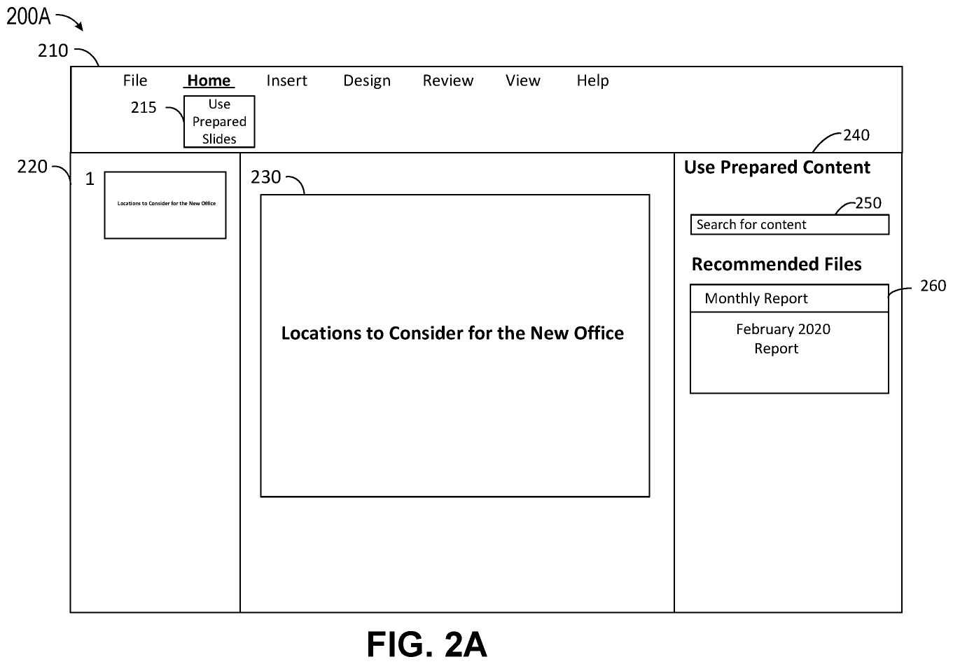

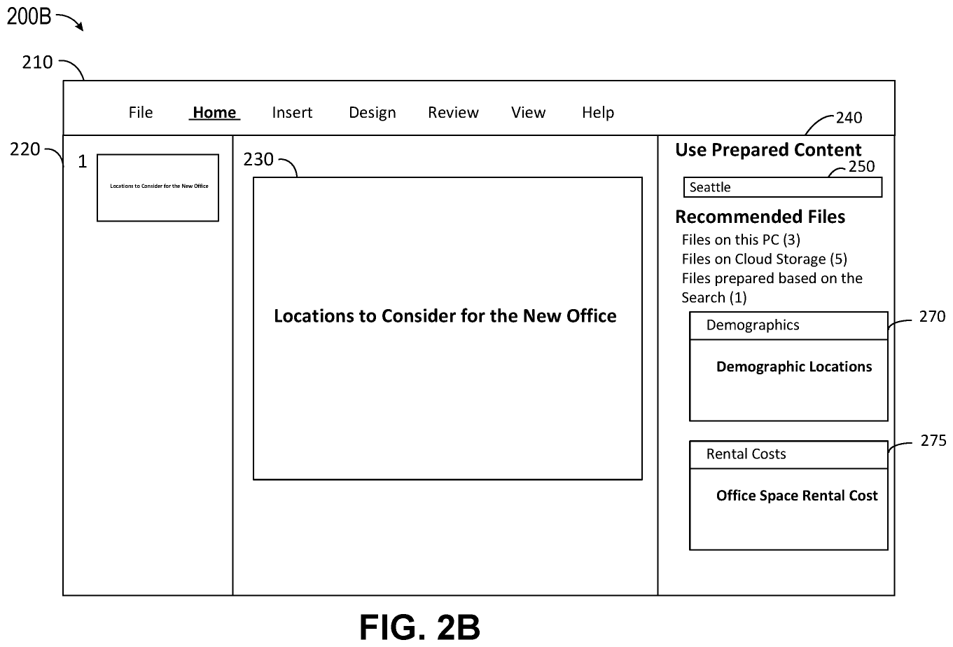

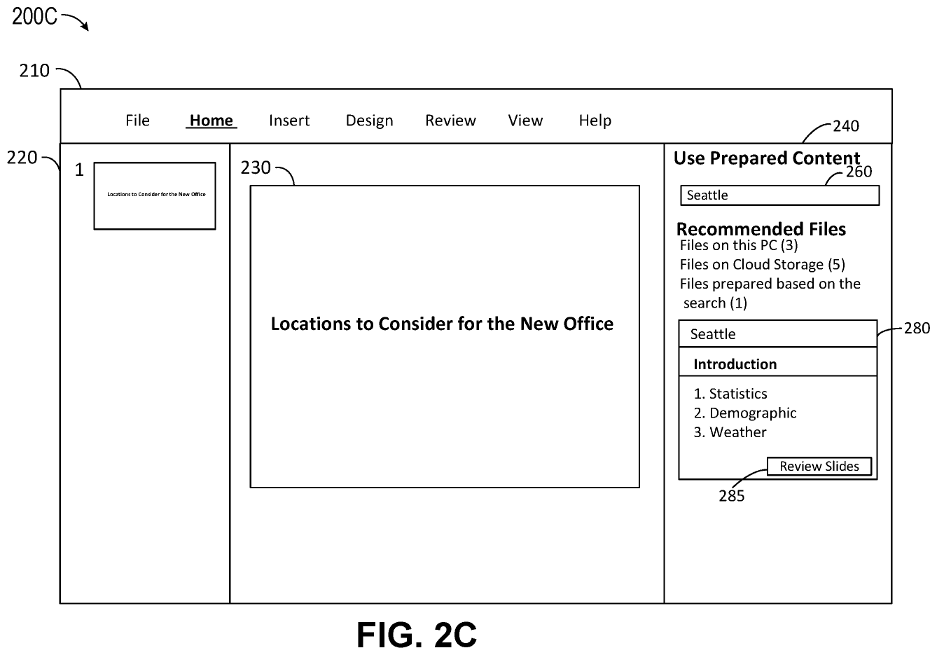

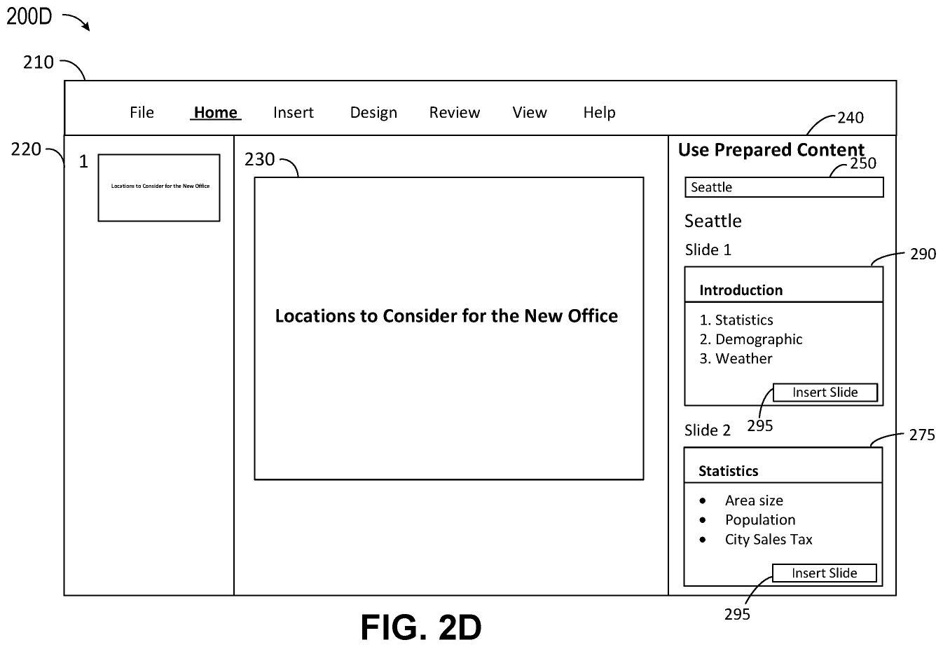

FIG. 2A-2D are example GUI screens for enabling a user to search for content for insertion into a document and for presenting content prepared for the document in the application. FIG. 2A is an example GUI screen 200A of a presentation application (e.g., Microsoft PowerPoint®) displaying an example document. GUI screen 200A may include a toolbar menu 210 containing various menu options, each of which may provide multiple UI elements for performing various tasks in the application. For example, the toolbar menu 210 may provide options for the user to perform one or more tasks to create or edit the document. Screen 200A may also contain a thumbnail pane 220 for displaying a thumbnail for each of the slides in the document and a content pane 230 for displaying the content of the document (e.g. displaying the slides one slide at a time). In one implementation, each of the thumbnail pane 220 and the content pane 230 may include a scroll bar for moving between the various slides in the document. The content may be displayed to the user for viewing and/or editing purposes and may be created by the user. For example, the user may utilize an input device (e.g., a keyboard) to insert input such as text, one or more images, icon(s), emoticons, and the like into the content pane 230.

As the user creates or edits the content of the content pane 230, a UI element may be provided for transmitting a request to review slides that have already been prepared for use in the document. The UI element may be any menu option that can be used to indicate a request by the user. In one implementation, the UI element is provided via a menu option such as the menu button 215 in the toolbar menu 210. When the user utilizes an input/output device such as a mouse to click on the menu button 215, this may result in the display of the prepared content pane 240. It should be noted that this merely presents an example manner in which the display of the prepared content pane 240 may be initiated. Many other methods of initiating the display of the prepared content pane 240 are possible.

The prepared content 240 may include an input box 250 for entering one or more search terms and a list of recommended files for use in the document. The list of recommended files may include documents recently opened and/or used in the presentation application (e.g., by the user or others associated with the user) and/or documents determined to be associated with the content or context of the current document. In one implementation, the list of recommended files is displayed in one or more thumbnails such as the thumbnail 260. The thumbnail 260 may display the first slide (or for other types of documents, the first page, the first spreadsheet, etc.) of the recommended file. The prepared content pane 240 may be displayed alongside the content pane 230 to provide a side-by-side view of the current content and the recommended content. Displaying the prepared content pane 240 alongside the content pane 230 may assist the user to compare the recommended content with the original version of the document on one screen.

Once one or more search terms are entered by the user in the input box 250 and a request for searching is submitted, a search request may be transmitted to one or more services (e.g., the search service 114 or local search service 132) for conducting a search for information related to the search terms. In one implementation, before conducting the search, the presentation application, the search service and/or the content identification and transformation service, may first identify one or more sources that should be searched. This may be performed by a source identifying engine such as the source identifying engine 154 of FIG. 1B and may involve using a classifier that examines the one or more search terms, classifies the search terms based on predetermined parameters (e.g., based on subject matter by using one or more models relating to text classification and topic modeling) and determines based on the classification which source(s) should be used for conducting the search. This may involve use of one or more ML models. For example, if the search term is “Seattle,” the classifier may classify the search term as related to geography. This classification may lead to the use of web sources that contain information about geographical locations (e.g., Wikipedia). However, if the search term relates to a medical term, a corresponding source associated with the medical field may be selected for searching. The sources may be publicly available sources (e.g., public webpages), sources associated with the application, enterprise sources (e.g., business intelligence and analytics data structures), and/or sources associated with the user (e.g., local or cloud storage).

It should be noted that the sources available for searching may contain a variety of different types of data. These may include webpages, different types of files (e.g., word documents, PDFs, spreadsheets, emails, images, multimedia and the like), tabular data structures, and others. Thus, the search service may have the ability to search for content in each of these different types of data. Furthermore, the content identification and transformation service may be able to parse the data, understand the content, and extract relevant content from the search results regardless of the type of file the data is contained in.

Once the search and preparation of content is complete, the search service and/or content identification and transformation service may provide the identified and/or prepared content in the prepared content 240 as depicted in FIG. 2B. In one implementation, the prepared content pane 240 of GUI screen 200B may display a list of various types of files identified during the search. For example, the recommended files may include local files located on the user's client device, files located in a cloud storage medium, and files prepared based on the search. As depicted in the prepared content pane of GUI screen 200B, the list of recommended files may provide the number of files falling into each category. In one implementation, the prepared content pane 240 also displays a thumbnail such as thumbnails 270 and 275 for one or more of the recommended files. One of more of the thumbnails may display the name of the identified file (e.g., demographics, rental costs, and the like) above the thumbnail. In one implementation, the location at which the file is stored may also be displayed.

Each of the categories of the recommended files may act as a link which when selected (e.g., when clicked) causes the prepared content pane 240 to display thumbnails (or any other UI elements for previewing a document) for the files associated with the selected category. For example, when the user selects “Files prepared based on the search,” the application may display the prepared content pane 240 depicted in FIG. 2C, where a thumbnail 280 for a file created based on content identified via the search is displayed. The file created based on the content identified in the search may be a new file (e.g., one that was not available before the search). The file may be created from content extracted from the search results and may include one or more slides, each of which may have been generated for a particular category of information relating to the search term(s) and/or the document. As discussed before, the slides may be created by parsing the content of the search results (e.g., using the parsing engine 160), identifying information that is relevant to the search terms(s) and/or the content and/or context of the document and categorizing the relevant information into one or more categories (e.g., using the relevant content identifier engine 162), retrieving the content and converting the information into a type of data that can be utilized by the application (e.g., by utilizing the retrieving and aggregating engine 164) and transforming the data into units that are usable in the application (e.g., slides, pages, tables, etc.) (by using the content transformation engine 168). To enable the user to examine the prepared file, the GUI screen 200C may display a menu option 285 for reviewing the slides that make up the file.

Once the menu option 285 is selected, the prepared content 240 may display each of the slides in the file, as depicted in FIG. 2D. For example, if the file created for the search term “Seattle” includes two slides (e.g. slide 1 and slide 2), as illustrated in GUI screen 200D, the content pane 240 may display those slides in reduced sizes to enable the user to review them alongside the content pane 230. As a result, reduced size slides such as slides 290 and 275 may be displayed in the content pane 240.

As illustrated, each of the slides may relate to a different category of information related to the searched topic (e.g., introduction, statistics, and the like). The content included in each of the slides may originate from one or more search results. Furthermore, the content may be collected from different sections of each search result. For example, information relating to statistics may be collected by parsing one or more search results and looking for numerical data that falls in the category of statistics. This may include numbers relating to subcategories of area size, population size, city sales tax, and the like. Each of these subcategories may be retrieved from a different search result or from a different portion of one search result. The retrieved information may then be aggregated, converted to a usable format and then transformed into one or more slides that can be easily inserted it into the document. The slides may be created and organized in a manner that is consistent with the content, context and/or format of the document. Furthermore, the slides may be organized to provide appropriate sequential order. For example, the slides may begin with an introduction slide that provides a summary of the remaining slides.

In one implementation, the format in which the information in each slide is presented may be determined by using one or more ML models and/or one or more classification algorithms (e.g., by utilizing the content transformation engine 168). For example, a rule-based classification algorithm may dictate that information provided in an introduction slide is formatted into bullet points or a numbered list, whereas an image is positioned directly in the middle of a slide. Tabular data, which is organized in rows and columns, on the other hand, may be formatted by being inserted in a table. Additionally and/or alternatively, one or more ML models may be used to determine the proper formatting for data in each slide. The ML models may take into account the category and/or subcategory of information the data belongs to, as well as the content, context and/or formatting styles used in the document. Furthermore, the ML models may consider user history, history of users within an enterprise, and/or global history of users. For example, the ML models may take into account the type of formatting often utilized by the user (e.g., when the user creates documents using the application) for data containing numbers. By taking into account the user's history, the content identification and transformation service may be able to present content that is in line with the user's style and as such more likely to be usable without a need for revisions.

To retrieve relevant information and transform it into proper formats, user data relating to the user's use of an application maybe collected and stored. For example, information relating to the user's interaction with recommended files (e.g., which files and/or slides are selected for use and which ones are not) may be collected and used to better train the ML models used in providing the content. To ensure that context is taken into account when using the information, layout, formatting style, and/or subject of the document (e.g. each slide in the document) may also be collected. Additionally, other information about the document and/or the user may be collected. For example, information about the type of document (e.g., word document, email, presentation document, etc.), the topic of the document, the position of the user within an organization (e.g., the user's job title or department to which the user belongs, if known), and other non-linguistic features such as the time of the day, the date the device was used, the person to whom the document is directed (e.g., the to line in an email), and the like may be collected and used to provide better content identification and transformation in the future. The user specific information may be used, in one implementation, to provide customized recommendations for the user. It should be noted that in collecting and storing this information, care must be taken to ensure privacy is persevered.

In one implementation, to ensure compliance with ethical and privacy guidelines and regulations, an optional UI element may be provided to inform the user of the types of data collected, the purposes for which the data may be used and/or to allow the user to prevent the collection and storage of user related data. The UI may be accessible as part of the features provided for customizing an application via a GUI displayed by the application. Alternatively, the information may be presented in a user agreement presented to the user when he/she first installs the application.

Once the user previews the reduced size slides in the prepared content pane 240, a menu option 295 may be selected to insert each slide directly into the document. In one implementation, selecting the menu option 295 causes the corresponding slide to be inserted after the slide displayed in the content pane 230. In this manner, an efficient and simple search from within an application can lead to direct insertion of prepared content into a document. This eliminates the need for multiple steps that are normally performed manually by a user. These may include searching multiple different sources which may require opening different applications and/or utilizing multiple windows, examining the results to locate relevant information, collecting the information, organizing the information into units usable for the document, and/or determining a proper format for the information. The process of reformatting the results into a manner consistent with the form and function of the content of the document itself often requires the need to for the user to have multiple UI screens open on the same device. These processes are not only time consuming for the user but may also be resource intensive. Furthermore, the processes may require multiple UI screens which may be inefficient and difficult to navigate. Thus, by providing one UI screen in the document to receive a search string for processing on a separate search engine, the technical solution avoids the need to utilize multiple applications and/or multiple UI screens on the user device and such saves screen space. Moreover, by automatically providing ready-to-insert content, the technical solution may greatly increase efficiency and usability of content creation applications.

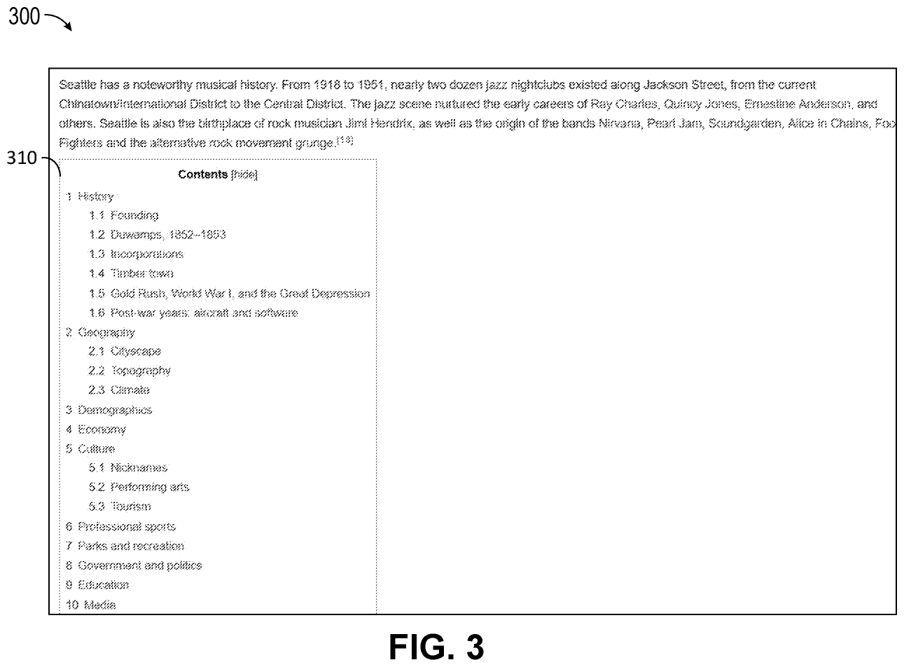

FIG. 3 depicts a partial view of content of an example search result 300 used in intelligently transforming content. The example search result 300 displays a portion of a webpage (e.g., a Wikipedia page) associated with the term “Seattle.” Once a search result, such as the search result 300 is identified as a relevant search result, one or more algorithms may be used to examine the content, identify relevant information within the content, and retrieve the relevant information in a manner that is conducive to efficient conversion and use. This may involve using text analytics algorithms such as natural language processing algorithms that allow topic or keyword extractions, for example, in the areas of text classification and topic modeling. Examples of such algorithms include, but are not limited to, term frequency-inverse document frequency (TF-IDF) algorithms and latent Dirichlet allocation (LDA) algorithms. Topic modeling algorithms may examine the content of the search result to identify and extract salient words and items within the content that may be recognized as keywords. Keywords may then help determine the type of information available in the content and/or how the information is organized. For example, by examining the content of the search result 300, one or more of the topics included in the contents table 310 (e.g., history, geography, demographics, economy, and the like) may be identified as keywords.

Once the keywords are identified, a determination may be made, (e.g., by using one or more ML models) as to which of the identified keywords are relevant to the document being created. This may involve taking into account the content and context of the document, the type of document being created (e.g., a presentation document), as well as user history and the like. For example, for the document displayed in FIGS. 2A-2D, since the title of the document relates to locations to consider for a new office, a determination may be made that geography, demography and economy of the city are relevant keywords, while its history is not relevant.

Once the relevant keywords are identified, data within the search result (e.g., the webpage) may be searched to identify content relating to each keyword. This may involve parsing and/or classifying the data. In one implementation, this is achieved by utilizing features provided by each type of search result. For example, when the search result is a webpage, a word document or a PDF document, headings may be used to classify the data. In an example, this may involve identifying data that is categorized under a particular heading as being related to that heading. For example, data that is positioned under the heading geography, may be identified as being related to geography. In this manner, not only are relevant search results identified, but they are parsed to understand their content and determine how and if the content relates to the document being created. The data can then be extracted in an organized manner to provide for easy conversion into a format usable by the content creation application.

It should be noted that although a webpage is depicted as an example search result, the type of search result identified is not limited to such data. For example, search results may include data in structured databases such as business and analytics data structures, which often store the data in a structural format involving tabular rows and columns. In such data structures, keyword identification and data relevance may be performed by analyzing the relationship between the different rows and columns.

Once data that is related to one or more relevant keyword is identified, it may be retrieved for conversion. This may involve transferring the data to a tabular data structure such as the data structure 400 of FIG. 4. FIG. 4 depicts a simplified example data structure utilized for collecting data from one or more search results to use in creating a unit of content for a content creation application. The table 400 may include a row identifying relevant keywords and one or more rows containing data for each relevant keyword. The relevant keywords may be identified within the provided search results and/or may be based on the content and context of the document. For example, for the document depicted in FIGS. 2A-2D, if the content created by the user included a set of slides for a different city (a city different than the one searched for), the title of each of those slides may provide a good indication for the type of data desired by the user. In an example, if the prepared slides include a slide titled real estate rental costs, that topic may be included in the list of keywords for which relevant data is searched and retrieved within the identified search results. Additionally and/or alternatively, such information may be taken into account when conducting the search and/or ranking the search results. For example, the topic may be added as a search term to the search request. In this manner, information that is more likely to be of use in creating the document may be presented to the user.

Once the keywords are identified and the data structure 400 is generated, data related to each keyword may be located and copied from one or more of the search results. For example, information related to geography may be collected from both a webpage and a tabular database. In one implementation, data from different sources may be copied into different cells of the data structure 400 (e.g. a separate row in the same column). The data that is collected may be raw data (e.g., having a uniform format). The data under each keyword category and/or multiple categories may then be examined to determine if and how it can be aggregated. This may involve using natural language processing and/or other text classification algorithms to understand the data and determine their relationship.

One or more other ML models may then be utilized to decide how the data should be organized. This may involve, for example, determining the type of content creation application used and identifying a usable unit of content within the application. For example, for a word document creation application, a usable unit of content may be a paragraph or a page, while for a spreadsheet application, the unit may be one sheet of data. Thus, depending on the type of application, the data may be aggregated into one or more usable units. For example, for a presentation application, data under each of the keywords in the table 400 may be transformed into a separate slide.

Once the data is categorized into separate units, a determination may be made as to how to format the data. This may involve using rule-based classification algorithms and/or other ML models. For example, data related to geography may be formatted into a plain text format and may include one or more images, while data relating to the economy may be presented in a bullet list.

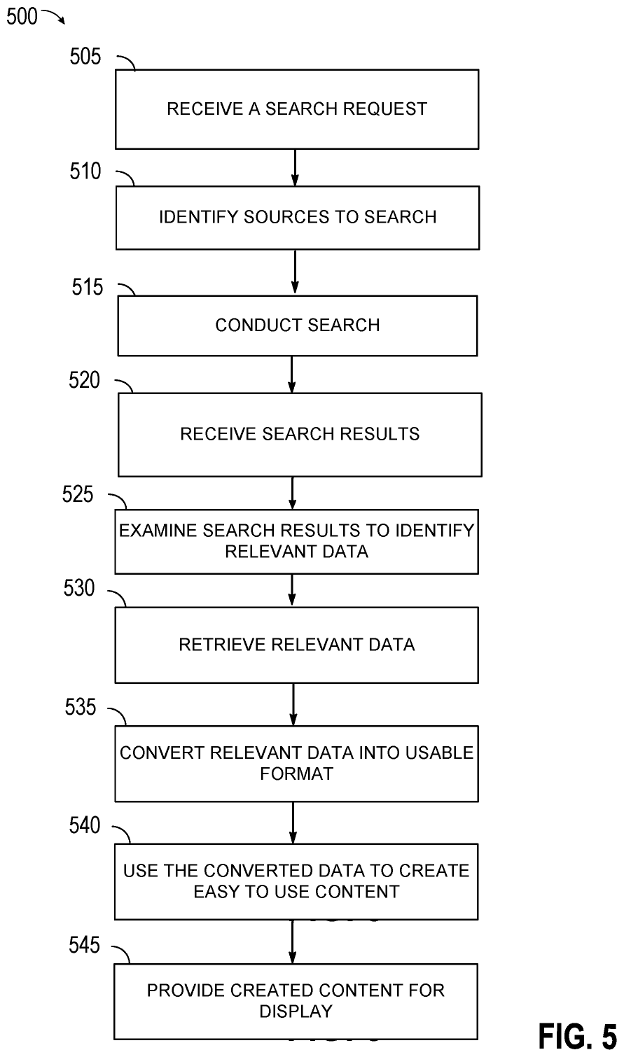

FIG. 5 is a flow diagram depicting an exemplary method 500 for providing intelligent content identification and transformation. In an example, one or more steps of method 500 may be performed by a search service (e.g., search service 114 or local search service 132 of FIG. 1) and/or a content identification and transformation service (e.g., content identification and transformation service 140 or content identification and transformation engine 124 of FIG. 1). Other steps of method 500 may be performed by the application providing content editing (e.g., applications 112 or applications 126 of FIG. 1).

At 505, method 500 may begin by receiving a request to provide prepared content for a document. This may occur, for example, when the user utilizes an input/output device (e.g. a mouse) coupled to a computer client device to insert one or more search terms (e.g., keywords, natural language, or other terms) in a UI element to request that prepared content related to the search term(s) be provided for the document. In one implementation, a request may be received when a predetermined action takes place within the content pane (e.g., a special character is entered, or a predetermined keyboard shortcut is pressed). In such cases, the application and/or service may automatically identify search term(s) related to the document. This may involve use of text classification algorithms and/or natural language processing algorithms to identify relevant keywords within the document for which a search may be useful.

Once a request to provide prepared content has been received, method 500 may proceed to identify appropriate sources to search, at 510. This may involve using a source identifying engine (e.g., source identifying engine 154 of FIG. 1B) which may include a classification algorithm that classifies the search term(s) and determines which source(s) correspond to the identified classification. In one implementation, the search request itself may identify one or more sources to search. For example, the user may specify the sources that should be searched for content.

After the appropriate sources have been identified, method 500 may proceed to conduct the search, at 515. Conducting the search may be performed by a search engine (e.g., search engine 156 of FIG. 1B) and may include performing a relevancy ranking which may be achieved by taking into account contextual data relating to the document, the user, the application, and the like. Once the search is conducted, one or more top relevant search results may be received, at 520. This may include providing a data structure (e.g., a list or table) containing data relating to the search results. For example, the data may include a location (e.g., a URL link or a storage medium) at which the search result may be accessed.

Once this information is available, method 500 may proceed to examine the content of the search results to identify data that is relevant to the document, at 525. This may be performed by a relevant content identifier engine (e.g., relevant content identifier engine 162 of FIG. 1B) and may involve identifying keywords that may be relevant to the document and then determining which portion of the content in the search result is associated with the relevant keyword. In one implementation, the process of identifying the relevant keywords includes taking into account information from the document. This may include examining the current content of the document to identify keywords that are likely to be relevant to the document but have not yet been covered in the document. For example, when the document relates to the city of Seattle, but it already includes a slide about its climate, a determination may be made that climate is not a relevant keyword. In another example, if the document relates to the city of Seattle and it mentions demographics but does not include any slides about demographics, it may be determined that demography is a relevant keyword.

Identifying relevant keywords may also be based on user history data (e.g., the types of slides the user generally creates). In one implementation, in addition to user history data, history data extracted from other users determined to be in a same category as the current user (e.g., in the same department, having the same job title, or being part of the same organization) may also be examined at this stage. Furthermore, the content identification and transformation service may consult a global database of user history and document contents to identify global patterns (e.g., which topics other users that created documents about Seattle used as their headings). In one implementation, in consulting the global database, the method identifies and uses data for users that are in a similar category as the current user. For example, the method may use history data from users with similar activities, similar work functions and/or similar work products. The database consulted may be global but also local to the current device.

After the relevant keywords have been identified, data associated with the keywords in the search result may be recognized and retrieved, at 530. This may be performed by a retrieving and aggregating engine (e.g., retrieving and aggregating engine 164 of FIG. 1B) and may involve the use of natural language processing algorithms that determine whether a sentence relates to the identified keyword. Additionally and/or alternatively, rule-based algorithms may be used. For example, once a relevant keyword is identified, sentences that fall under a heading that contains the keyword may be recognized as being related to the keyword (e.g., if the heading is demographics, the paragraph(s) that follow the heading are related to demographics). Thus, once search results are identified, data contained in those search results may be examined and understood to allow for extraction of relevant data.

The relevant data may be retrieved from the search result (e.g., copied) and converted into a format that can be easily used, at 535. This may be achieved by removing unnecessary formatting that may be present in the data, by adding additional contextual information pulled or derived from other data sources or by adding additional formatting to enhance the original formatting. For example, if the data is in the form of bullet points, the bullets may be removed. The determination regarding which formats should be removed and which ones should remain may be based on the type of formatting, the type of data, the type of document the data is being used for, and the like. In one implementation, one or more ML models may be used to make this determination.

Once retrieved, the data may be stored temporarily in a data structure, such as the data structure 400 of FIG. 4. In one implementation, the retrieved data may include metadata relating to the search result from which the data was obtained. This information may then be used to provide citation to the search result when the data is used to create content for the document. For example, in addition to creating slides containing content from the search results, a “references” slide may also be created that includes a list of search results from which the data was collected.

The collected data may then be used by a content transformation engine (e.g., content transformation engine 168 of FIG. 1B) to create easy to use content for the document, at 540. In one implementation, content is created in units that can be easily inserted into the document. For example, for a presentation document, content may be created in the form of one or more slides that can be inserted directly into the document. In another example, data may be created in units that are one page long and/or one paragraph long for a word document. For a spreadsheet document, data may be created in the form of one sheet of data. Other examples are also possible. To create such content, data from various search results may be combined to create each unit of data. For example, to create a slide relating to statistics about Seattle, data that has been retrieved from a Wikipedia page, a spreadsheet, and a word document may be aggregated to generate various categories of statistics in the slide. Thus, the step of creating content also includes examining and understanding data to generate highly useful content.

Once it is determined what data should be included in a given unit (e.g., a slide, a paragraph, or a data sheet), a decision may be made with regards to the type of formatting that should be applied to the data. This may involve examining the data to identify a type of formatting that is conducive to readability and easy use. For example, the content identification and transformation service may determine that data relating to statistics is easier to read and understand when presented in a table format, while a list may be presented better via bullet points. Selecting an appropriate type of formatting may involve use of rule-based algorithms and/or ML models. In one implementation, user history data along with history data of other users may be used to make this determination. This may involve examining the type of formatting often used by the user and/or used by other users for certain types of data.

Thus, ML algorithms may be used during various stages of method 500 to examine activity history of the user within the document or within the user's use of the application to identify patterns in the user's usage. In addition to history data relating to how the user creates content in the application, the types of recommended content accepted by the user in a previous session of the document (or earlier in the current session) may also be examined to identify patterns. In another example, data relating to any changes made to a recommended content may also be examined and taken into account. For example, if a user inserts a recommended slide into a document and then changes the format of the content from bullet points to a numbered list, that information may be collected and used in the future to format the content in accordance with the user's preferences. The user history which is collected and used may be limited to the user's recent history (i.e., during a specific recent time period or during the current session) or may be for the entirety of the user's use of the application. This information may be stored locally and/or in the cloud. In one implementation, the history data may be stored locally temporarily and then transmitted in batches to a data store in the cloud which may store each user's data separately for an extended period of time, as long as the user continues using the application or as long as the user has granted permission for such storage and use.

In one implementation, one or more steps involved in identifying and transforming content may be performed by utilizing two or more different types of trained ML models. One type could be a personal model which is trained based on each user's personal information and another could be a global model that is trained based on examination of a global set of other users' information. A hybrid model may be used to examine users similar to the current user and to generate results based on activities of other users having similar characteristics (same organization, having same or similar job titles, creating similar types of documents, and the like) as the current user. For example, it may examine users that create similar artifacts as the current user or create documents having similar topics. Another type of model that could be developed may be a domain and/or organization specific model. The ML models for such a model may be trained specifically based on documents the organization creates or documents focused on a specific domain. Any of the models may collect and store what is created and/or recommended and record how the user interacts with the recommendations (e.g., which slides they choose to insert). This ensures that every time a user interacts with the system, the models learn from the interaction to make the content creation better. The different models may be made aware of each other, so that they each benefit from what the other models are identifying, while focusing on a specific aspect of the task.

It should be noted that the models identifying and transforming content may be hosted locally on the client (e.g., local enhancement engine) or remotely in the cloud (e.g., content identification and creation service). In one implementation, some models are hosted locally, while others are stored in the cloud. This enables the client to provide some content identification and creation even when the client is not connected to a network. For example, the client may be able to provide some content identification and creation based on the current document and local sources available for searching. Hosting the models locally may also address privacy concerns. Once the client connects to the network, the application may be able to create better content.

Once content is created, it may be provided for display, at 545. This may be achieved, by transmitting the created content from the content identification and creation service to the user's client device for display within the application (for instances where a cloud-based service is used). This may result in the user merely receiving the prepared content, instead of receiving the search results and/or data retrieved from the search results. This can substantially reduce system and bandwidth requirements for the client device.

FIG. 6 is a block diagram 600 illustrating an example software architecture 602, various portions of which may be used in conjunction with various hardware architectures herein described, which may implement any of the above-described features. FIG. 6 is a non-limiting example of a software architecture and it will be appreciated that many other architectures may be implemented to facilitate the functionality described herein. The software architecture 602 may execute on hardware such as client devices, native application provider, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 608 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 624. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 620 and/or third-party applications 622. Examples of built-in applications 620 may include, but are not limited to, a contacts application, a browser application, a location application, a media application, a messaging application, and/or a game application. Third-party applications 622 may include any applications developed by an entity other than the vendor of the particular system. The applications 620 may use functions available via OS 614, libraries 616, frameworks 618, and presentation layer 624 to create user interfaces to interact with users.

Some software architectures use virtual machines, as illustrated by a virtual machine 628. The virtual machine 628 provides an execution environment where applications/modules can execute as if they were executing on a hardware machine (such as the machine 600 of FIG. 6, for example). The virtual machine 628 may be hosted by a host OS (for example, OS 614) or hypervisor, and may have a virtual machine monitor 626 which manages operation of the virtual machine 628 and interoperation with the host operating system. A software architecture, which may be different from software architecture 602 outside of the virtual machine, executes within the virtual machine 628 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via

Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A data processing system comprising:
a processor; and
a memory in communication with the processor, the memory storing executable instructions that, when executed by the processor, cause the data processing system to perform functions of:
   receiving a search query generated within a content creation application, the content creation application used for creating content for a document and the search query containing one or more terms for conducting a search for content to be used in the document;
   providing the one or more terms to a search engine for searching one or more sources;
   receiving one or more search results from the search engine;
   inputting data contained in at least one of the one or more search results into a first machine-learning (ML) model to parse the inputted data and rank relevance of the inputted data to content associated with the document;
   obtaining the parsed and ranked data as a first output from the first ML model;
   retrieving one or more data segments from the first output;
   inputting the retrieved one or more segments into a second ML model to organize the retrieved one or more data segments into one or more units of content that can be used in the document;
   obtaining the one or more units of content as a second output from the second ML model; and
providing the second output for display within the content creation application.
Item 2. The data processing system of item 1, wherein parsing the inputted data and ranking relevance of the inputted data includes identifying one or more relevant terms in the at least one of the one or more search result.
Item 3. The data processing system of item 2, wherein parsing the inputted data and ranking relevance of the inputted data further includes identifying the one or more segments as segments associated with at least one of the one or more relevant terms.
Item 4. The data processing system of item 4, wherein retrieving the one or more data segments includes retrieving the metadata associated with the one or more data segments.
Item 5. The data processing system of any of the preceding items, wherein the instructions further cause the processor to cause the data processing system to perform functions of:
removing a formatting of data contained in at least one of the one or more data segments; and
upon removing the formatting, storing the one or more data segments in a data structure for use in creating the one or more units of content.
Item 6. The data processing system of any of the preceding items, wherein the instructions further cause the processor to cause the data processing system to perform functions of:
identifying the one or more sources for conducting the search.
Item 7. The data processing system of any of the preceding items, wherein retrieving the one or more data segments from the first output includes:
   inputting the parsed and ranked data into a third ML model to retrieve and aggregate at least a portion of the parsed and ranked data; and obtaining the one or more segments as a third output from the third ML model
Item 8. A method for identifying and transforming content for use in a document, comprising:
   receiving a search query generated within a content creation application, the content creation application used for creating content for the document and the search query containing one or more terms for conducting a search for content to be used in the document;
   providing the one or more terms to a search engine for searching one or more sources;
   receiving one or more search results from the search engine;
   inputting data contained in at least one of the one or more search results into a first machine-learning (ML) model to parse the inputted data and rank relevance of the inputted data to content associated with the document;
   obtaining the parsed and ranked data as a first output from the first ML model;
   retrieving one or more data segments from the first output;
   inputting the retrieved one or more segments into a second ML model to organize the retrieved one or more data segments into one or more units of content that can be used in the document;
   obtaining the one or more units of content as a second output from the second ML model; and
   providing the second output for display within the content creation application.
Item 9. The method of item 8, wherein parsing the inputted data and ranking relevance of the inputted data includes identifying one or more relevant terms in the at least one of the one or more search result.
Item 10. The method of item 9, wherein parsing the inputted data and ranking relevance of the inputted data further includes identifying the one or more segments as segments associated with at least one of the one or more relevant terms.
Item 12. The method of items 8 to 11, wherein retrieving the one or more data segments includes retrieving the metadata associated with the one or more data segments.
Item 13. The method of items 8 to 12, further comprising:
   removing a formatting of data contained in at least one of the one or more data segments; and upon removing the formatting, storing the retrieved data in a data structure for use in creating the one or more units of content.
Item 14. The method of items 8 to 13, wherein the at least one of the one or more units of content includes one of a slide when the document is a presentation document, a paragraph when the document is a word document, a page when the document is a word document, or a data sheet when the document is a spreadsheet document.
Item 15. A computer program that, when executed, causes a programmable device to carry out the method of any one of items 8 to 14.
Item 16. A data processing system comprising:
a processor; and
a memory in communication with the processor, the memory comprising executable instructions that, when executed by, the processor, cause the data processing system to perform functions of:
transmitting a search query generated within a content creation application to a search service, the content creation application used for creating content for a document and the search query containing one or more terms for conducting a search for content to be used in the document, the one or more terms comprising one or more search terms that a user entered into a UI element of the content creation application and contextual information about the document;
providing the one or more terms to a search engine of the search service for searching one or more sources;
transmitting to a content identification and transformation service one or more search results from the search engine;
at the content identification and transformation service:
   inputting data contained in at least one of the one or more search results into a first machine-learning, ML, model to parse the inputted data and rank relevance of the inputted data to content associated with the document;
   obtaining the parsed and ranked data as a first output from the first ML model;
   retrieving one or more data segments from the first output; and
   inputting the retrieved one or more segments into a second ML model to organize the retrieved one or more data segments into one or more units of content that can be used in the document, the organizing including:
      removing a formatting of data contained in at least one of the one or more data segments; and
      upon removing the formatting, storing the one or more data segments
   in a data structure for use in creating the one or more units of content; and transmitting the one or more units of content from the content identification and transformation service to the content creation application for display within the content creation application,
wherein the first and second ML models are trained using user data from a large number of users to identify patterns in user activity, determine associations between content, determine how to aggregate and/or format content for the document.
Item 17. The data processing system of item 16, wherein parsing the inputted data and ranking relevance of the inputted data includes identifying one or more relevant terms in the at least one of the one or more search result.
Item 18. The data processing system of item 17, wherein parsing the inputted data and ranking relevance of the inputted data further includes identifying the one or more segments as segments associated with at least one of the one or more relevant terms.
Item 19. The data processing system of item 18, wherein retrieving the one or more data segments includes retrieving the metadata associated with the one or more data segments.
Item 20. The data processing system of any of items 16-19, wherein the instructions further cause the processor to cause the data processing system to perform functions of:
identifying the one or more sources for conducting the search.
Item 21. The data processing system of any of items 16-20, wherein retrieving the one or more data segments from the first output includes:
inputting the parsed and ranked data into a third ML model to retrieve and aggregate at least a portion of the parsed and ranked data; and
obtaining the one or more segments as a third output from the third ML model.
Item 22. A method for identifying and transforming content for use in a document, comprising:
transmitting a search query generated within a content creation application to a search service, the content creation application used for creating content for the document and the search query containing one or more terms for conducting a search for content to be used in the document, the one or more terms comprising one or more search terms that a user entered into a UI element of the content creation application and contextual information about the document;
providing the one or more terms to a search engine of the search service for searching one or more sources;
transmitting to a content identification and transformation service (140) one or more search results from the search engine;
at the content identification and transformation service:
   inputting data contained in at least one of the one or more search results into a first machine-learning, ML, model to parse the inputted data and rank relevance of the inputted data to content associated with the document;
   obtaining the parsed and ranked data as a first output from the first ML model;
   retrieving one or more data segments from the first output; and
   inputting the retrieved one or more segments into a second ML model to organize the retrieved one or more data segments into one or more units of content that can be used in the document, the organizing including:
      removing a formatting of data contained in at least one of the one or more data segments; and
      upon removing the formatting, storing the retrieved data in a data structure for use in creating the one or more units of content; and
transmitting the one or more units of content from the content identification and transformation service to the content creation application for display within the content creation application
wherein the first and second ML models are trained using user data from a large number of users to identify patterns in user activity, determine associations between content, determine how to aggregate and/or format content for the document.
Item 23. The method of item 22, wherein parsing the inputted data and ranking relevance of the inputted data includes identifying one or more relevant terms in the at least one of the one or more search result.
Item 24. The method of item 23, wherein parsing the inputted data and ranking relevance of the inputted data further includes identifying the one or more segments as segments associated with at least one of the one or more relevant terms.
Item 25. The method of item 24, wherein retrieving the one or more data segments includes retrieving the metadata associated with the one or more data segments.
Item 26. The method of any of items 22 to 25, further comprising: combining segments from two different search results to create the at least one of the one or more units of content.
Item 27. The method of any of items 22 to 26, wherein the at least one of the one or more units of content includes one of a slide when the document is a presentation document, a paragraph when the document is a word document, a page when the document is a word document, or a data sheet when the document is a spreadsheet document.
Item 28. A computer program that, when executed, causes a programmable device to carry out the method of any one of items 22 to 27.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system comprising:
a processor; and
a memory in communication with the processor, the memory comprising executable instructions that, when executed by, the processor, cause the data processing system to perform functions of:
receiving a search query generated within a content creation application, the content creation application used for creating content for a document and the search query containing one or more terms for conducting a search for content to be used in the document;
providing the one or more terms to a search engine for searching one or more sources;
receiving one or more search results from the search engine;
inputting data contained in at least one of the one or more search results into a first machine-learning (ML) model to parse the inputted data and rank relevance of the inputted data to content associated with the document;
obtaining the parsed and ranked data as a first output from the first ML model;
retrieving one or more data segments from the first output;
inputting the retrieved one or more segments into a second ML model to organize the retrieved one or more data segments into one or more units of content that can be used in the document;
obtaining the one or more units of content as a second output from the second ML model; and
providing the second output for display within the content creation application.

2. The data processing system of claim 1, wherein parsing the inputted data and ranking relevance of the inputted data includes identifying one or more relevant terms in the at least one of the one or more search result.

3. The data processing system of claim 2, wherein parsing the inputted data and ranking relevance of the inputted data further includes identifying the one or more segments as segments associated with at least one of the one or more relevant terms.

4. The data processing system of claim 3, wherein retrieving the one or more data segments includes retrieving the metadata associated with the one or more data segments.

5. The data processing system of claim 1, wherein the instructions further cause the processor to cause the data processing system to perform functions of:
removing a formatting of data contained in at least one of the one or more data segments; and
upon removing the formatting, storing the one or more data segments in a data structure for use in creating the one or more units of content.

6. The data processing system of claim 1, wherein the instructions further cause the processor to cause the data processing system to perform functions of:
identifying the one or more sources for conducting the search.

7. The data processing system of claim 1, wherein retrieving the one or more data segments from the first output includes:
inputting the parsed and ranked data into a third ML model to retrieve and aggregate at least a portion of the parsed and ranked data; and
obtaining the one or more segments as a third output from the third ML model.

8. A method for identifying and transforming content for use in a document, comprising:
receiving a search query generated within a content creation application, the content creation application used for creating content for the document and the search query containing one or more terms for conducting a search for content to be used in the document;
providing the one or more terms to a search engine for searching one or more sources;
receiving one or more search results from the search engine;
inputting data contained in at least one of the one or more search results into a first machine-learning (ML) model to parse the inputted data and rank relevance of the inputted data to content associated with the document;
obtaining the parsed and ranked data as a first output from the first ML model;
retrieving one or more data segments from the first output;
inputting the retrieved one or more segments into a second ML model to organize the retrieved one or more data segments into one or more units of content that can be used in the document;
obtaining the one or more units of content as a second output from the second ML model; and
providing the second output for display within the content creation application.

9. The method of claim 8, wherein parsing the inputted data and ranking relevance of the inputted data includes identifying one or more relevant terms in the at least one of the one or more search result.

10. The method of claim 9, wherein parsing the inputted data and ranking relevance of the inputted data further includes identifying the one or more segments as segments associated with at least one of the one or more relevant terms.

11. The method of claim 10, wherein retrieving the one or more data segments includes retrieving the metadata associated with the one or more data segments.

12. The method of claim 8, further comprising:
removing a formatting of data contained in at least one of the one or more data segments; and
upon removing the formatting, storing the retrieved data in a data structure for use in creating the one or more units of content.

13. The method of claim 8, further comprising:
combining segments from two different search results to create the at least one of the one or more units of content.

14. The method of claim 8, wherein the at least one of the one or more units of content includes one of a slide when the document is a presentation document, a paragraph when the document is a word document, a page when the document is a word document, or a data sheet when the document is a spreadsheet document.

15. (canceled)

16. A non-transitory computer readable medium on which are stored instructions that when executed cause a programmable device to perform functions of:
receiving a search query generated within a content creation application, the content creation application used for creating content for a document and the search query containing one or more terms for conducting a search for content to be used in the document;
providing the one or more terms to a search engine for searching one or more sources;
receiving one or more search results from the search engine;
inputting data contained in at least one of the one or more search results into a first machine-learning (ML) model to parse the inputted data and rank relevance of the inputted data to content associated with the document;
obtaining the parsed and ranked data as a first output from the first ML model;
retrieving one or more data segments from the first output;
inputting the retrieved one or more segments into a second ML model to organize the retrieved one or more data segments into one or more units of content that can be used in the document;
obtaining the one or more units of content as a second output from the second ML model; and
providing the second output for display within the content creation application.

17. The non-transitory computer readable medium of claim 16, wherein parsing the inputted data and ranking relevance of the inputted data includes identifying one or more relevant terms in the at least one of the one or more search result.

18. The non-transitory computer readable medium of claim 17, wherein parsing the inputted data and ranking relevance of the inputted data further includes identifying the one or more segments as segments associated with at least one of the one or more relevant terms.

19. The non-transitory computer readable medium of claim 18, wherein retrieving the one or more data segments includes retrieving the metadata associated with the one or more data segments.

20. The non-transitory computer readable medium of claim 16, wherein the instructions further cause the processor to cause the programmable device to perform functions of:
removing a formatting of data contained in at least one of the one or more data segments; and
upon removing the formatting, storing the one or more data segments in a data structure for use in creating the one or more units of content.

21. The non-transitory computer readable medium of claim 16, wherein the instructions further cause the processor to cause the programmable device to perform functions of identifying the one or more sources for conducting the search.
